(19) United States
(12) Patent Application Publication
(10) Pub. No.: US 2024/0353024 A1
(43) Pub. Date: Oct. 24, 2024

(54) PIPE ARRANGEMENT FOR TRANSPORTING A TEMPERATURE CONTROL MEDIUM

(71) Applicant: TI AUTOMOTIVE TECHNOLOGY CENTER GMBH, Rastatt (DE)

(72) Inventors: Hans JENSEN, Dettingen Unter Teck (DE); Albert BOECKER, Ettlingen (DE); Matthias WINTER, Rastatt (DE)

(21) Appl. No.: 18/684,661

(22) PCT Filed: Aug. 18, 2022
(86) PCT No.: PCT/IB2022/057768

§ 371 Date: Feb. 17, 2024

(30) Foreign Application Priority Data
Aug. 19, 2021 (DE) 10 2021 121 587.0

(51) Int. Cl. F16K 37/00; F16K 31/06

(52) U.S. Cl. CPC F16K 37/005; F16K 31/06; F16K 37/0091

(57) ABSTRACT

A pipe arrangement for transporting a temperature control medium, having a base body made of polymeric material, wherein the base body has at least one fluid channel which receives the temperature control medium. At least one first functional element which is associated with the fluid channel is accommodated in the base body, wherein the first functional element interacts with a second functional element by means of electromagnetic and/or magnetic interaction.

### RELATED APPLICATIONS

The present disclosure claims priority to and is a national phase application of PCT Application PCT/IB2022/057768, filed Aug. 18, 2022, which claims priority to and the benefit of German Utility Model application No. 20202121587.0, filed Aug. 19, 2021, the entire contents of which is incorporated herein by reference.

### FIELD

The present disclosure relates to a tube or pipe arrangement for transporting a temperature control medium, comprising a base body made of polymeric material, wherein the base body has at least one fluid channel which receives the temperature control medium, and wherein at least one first functional element which is associated with the fluid channel is accommodated in the base body.

### BACKGROUND

In particular in electromobility, it is necessary to control the temperature of components so that they exhibit an optimal performance. For example, electric vehicle batteries, especially lithium-ion batteries, exhibit an optimal performance only within a limited temperature spectrum. Depending on the ambient temperature, it may therefore be necessary to heat or cool the batteries. For this purpose, an electric vehicle usually has a temperature control circuit with a pipe arrangement through which temperature control media can be fed to the storage cells of the battery in order to temper them within the desired temperature spectrum. The installation space in such cases is usually limited, therefore the pipe arrangement should be particularly compact.

In addition to the batteries, however, it may also be necessary to control the temperature, in particular to cool, other components of the drive unit of electric vehicles. These include, for example, power electronics and electric motors. The charging electronics and the associated plug connections in lines can also be temperature controlled, in particular cooled, via a temperature control circuit, which is particularly relevant in connection with fast charging processes.

There may also be a need for temperature control in other parts of the vehicle's electronic, especially in the area of the sensors and the on-board computers. If a vehicle is equipped for autonomous driving, powerful sensors and powerful computers are required, wherein the systems are redundantly present and therefore can emit high amounts of heat even in a small space, so there is a need for temperature control or cooling by a temperature control unit.

Temperature control media are also used in air-conditioning systems. Air-conditioning systems, in particular mobile air-conditioning systems, comprise a pipe arrangement which enables the transport of the temperature control medium between the individual units of the air-conditioning system. In mobile air-conditioning systems, for example in air-conditioning systems for vehicle interiors, the pipe arrangement is a comparatively complex structure. It is known for this kind of pipe arrangement to be formed from one base body in a materially integral one-piece design by means of blow molding. One or more functional elements may be integrated into the pipe arrangement. These can be, for example, throttle valves, check valves, switchable valves, rotary valves, pumps, flow sensors, connecting elements, connectors or temperature sensors. The functional element is arranged within the pipe arrangement in the base body so that it is in contact with the temperature control medium.

We have discovered one problem here is that, in order to contact the functional element, it may be necessary to feed lines, cables or actuators through the wall of the base body in order to be able to contact the functional element. However, in this context, it is disadvantageous that, depending on the arrangement within the pipe arrangement, the functional element is particularly difficult to reach, and that leaks can result from the feedthrough.

### BRIEF SUMMARY

The disclosure provides a tube or pipe arrangement for the transport of temperature control media which exhibits a high degree of functional reliability.

The tube or pipe arrangement for transporting a temperature control medium according to the present disclosure comprises a base body made of polymeric material, wherein the base body has at least one fluid channel which receives the temperature control medium, and wherein at least one first functional element is accommodated in the base body and associated with the fluid channel, wherein the first functional element interacts with a second functional element by means of electromagnetic and/or magnetic interaction.

The second functional element acts on the first functional element and, according to a simple embodiment, enables the data exchange between the first functional element and the second functional element. For example, the first functional element may be formed as a flow sensor or a temperature sensor, and the data sensed by the sensor is transmitted electromagnetically to the second functional element. The second functional element is arranged outside the pipe arrangement. The second functional element can be attached to the outside of the base body. A receptacle for fastening the second functional element can be provided on the outer wall of the base body. Alternatively, the second functional element may be separated and spaced apart from the base body. For example, the second functional element may be arranged on a component adjacent to the pipe arrangement, wherein the arrangement of the second functional element is made in such a way that the second functional element may interact with the first functional element.

In principle, it is conceivable that the pipeline has a plurality of first functional elements, for example a plurality of sensors that detect different parameters of the temperature control medium. In this case, several first functional elements can interact with one or more second functional elements. It is conceivable, for example, that a second functional element is provided in the form of a measurement transducer, which acquires data from several first functional elements formed as sensors.

Data transmission can, for example, take place via radio technology using near-field communication (NFC). In order for the first functional element and the second functional element to interact electromagnetically, the first functional element may be provided with a power source, for example in form of a battery. However, it is also conceivable that the first functional element obtains the energy required for the electromagnetic interaction as auxiliary energy from the temperature control medium via a unit. It is also conceivable that the energy required for the interaction is provided via electromagnetic interaction, for example using RFID technology.

It is also conceivable that the second functional element inductively transmits the energy required for the electromagnetic interaction to the functional element in the form of electrical energy.

According to a further embodiment, the first functional element may interact with the second functional element via magnetic interaction. This is particularly advantageous if the first functional element has movable elements that are to influence the temperature control medium, for example if the first functional element is formed as a valve. Thereby, a switching operation of the first functional element is triggered by magnetic interaction between the first functional element and the second functional element. For this purpose, the first functional element can be equipped with ferromagnetic components which can be set in motion via an electromagnet arranged in the second functional element.

The base body comprises at least one fluid channel, wherein at least one first functional element is associated with the fluid channel. As a result, the first functional element is in direct contact with the temperature control medium and can either directly detect status parameters of the temperature control medium, such as the temperature, the volume flow or the pressure, or influence the temperature control medium itself, for example the volume flow or the temperature.

The first functional element can influence the volume flow of the temperature control medium. For this purpose, the first functional element can contain controllable, movable elements. In particular, it is conceivable that the first functional element is formed as a valve, especially a solenoid valve. Preferably, the first functional element is then in contact with the second functional element via magnetic interaction. A switching operation of the first functional element is triggered by the second functional element when it magnetically interacts with the first functional element. In this case, the first functional element can contain the valve body and at least part of the electromagnet that triggers the switching operation. Another part of the electromagnet can be integrated into the second functional element. It is also conceivable that the electromagnet is accommodated in the second functional element and transmits switching commands to magnetic transmission elements which are accommodated in the first functional element and transmit the switching command of the electromagnet to the valve body. Accordingly, the second functional element can be formed as a control device and influence the first functional element.

The first functional element can detect status parameters of the temperature control medium. Status parameters are in particular the volume flow, the pressure and the temperature of the temperature control medium. Accordingly, the first functional element is formed as a sensor, wherein the first functional element preferably comprises a transmitter in addition which transmits the values detected by the sensor to the second functional element. Accordingly, the second functional element comprises a receiver which receives signals from the transmitter accommodated in the first functional element. The communication can be performed by means of near-field communication. Accordingly, the second functional element can be formed as a measurement transducer. Data transmission is performed preferably via electromagnetic interaction.

The base body may have an inner wall that bounds the fluid channel and an outer wall, wherein the first functional element is allocated to the inner wall and the second functional element is allocated to the outer wall. As a result, the first functional element and the second functional element are separated by the base body, wherein the distance between the first functional element and the second functional element results from the wall thickness of the base body. Here, it is particularly advantageous that no openings, holes and the like are required through which an opening is introduced in the base body.

The pipe arrangement may include a plurality of fluid channels, wherein one or more first functional elements may be allocated to each fluid channel. Furthermore, the pipe arrangement can be designed as a plastic pipe or as a quick connector.

The base body can be designed as a blow-molded part. This allows the production of a one-piece base body with one or more fluid channels and with a complicated geometry. Furthermore, it is conceivable to already arrange one or more first functional elements in the base body during the blow molding process. This reduces the risk of leakage in particular. However, it is also conceivable to form the base body by means of extrusion.

### BRIEF DESCRIPTION OF THE DRAWINGS

Some embodiments of the pipe arrangement according to the present disclosure are explained in more detail below with the help of the figures. Each show schematically:

FIG. 1 depicts a pipe arrangement with a sensor in sectional view; and

FIG. 2 depicts a pipe arrangement with a valve in sectional view.

### DETAILED DESCRIPTION

The figures show a tube or pipe arrangement 1 for transporting a temperature control medium, comprising a base body 2 made of polymeric material, wherein the base body 2 has a fluid channel 3 which receives the temperature control medium. The base body 2 is formed as a blow-molded part. The present base body 2 is formed as a plastic tube and has a fluid channel 3. In other embodiments, the base body 2 is formed as a quick connector or as a distribution structure with multiple fluid channels 3. A first functional element 4 is accommodated in the base body and is associated with the fluid channel 3, wherein the first functional element 4 interacts with a second functional element 5 by means of electromagnetic, or magnetic, interaction.

The base body 2 has an inner wall 6 that bounds the fluid channel 3 and an outer wall 7, wherein the first functional element 4 is associated with the inner wall 6 and the second functional element 5 with the outer wall 7. Accordingly, the second functional element 5 is arranged outside the base body 2.

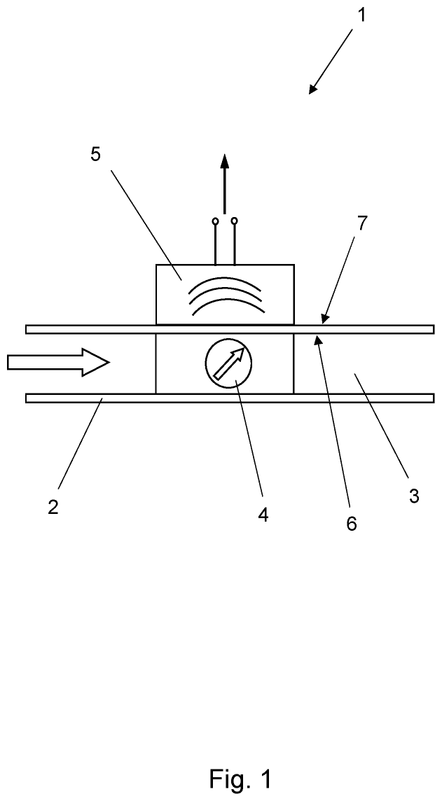

In the embodiment according to FIG. 1, the first functional element 4 is designed to detect status parameters of the temperature control medium. Accordingly, the first functional element 4 forms a measurement transducer in the form of a sensor. The data, i.e. the status parameters, are transmitted to the second functional element 5 by means of electromagnetic interaction. In the present embodiment, this is done by means of near-field communication. The status parameters detected by the sensor are the temperature, the pressure and the volume flow of the temperature control medium.

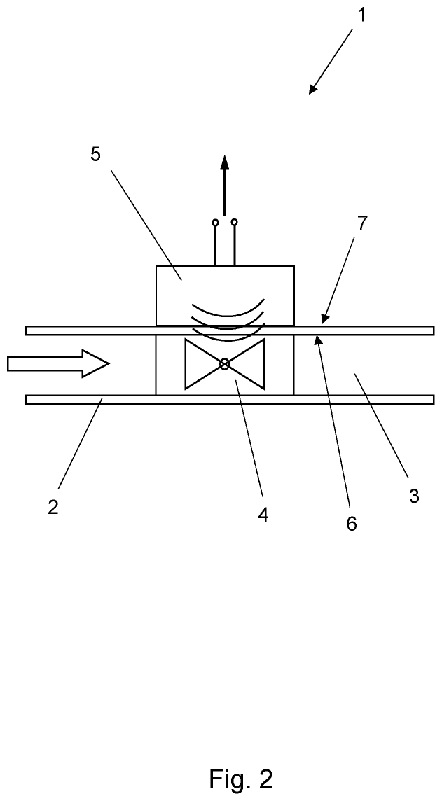

In the embodiment according to FIG. 2, the first functional element 4 is designed to influence the volume flow of the temperature control medium. For this purpose, the first functional element 4 contains controllable, movable elements in the form of ferromagnetic elements, which are influenced and set in motion by an electromagnet accommodated in the second functional element 5. The ferromagnetic elements in turn move a valve body so that the fluid channel 3 can be selectively opened or closed.

In compliance with a further embodiment, the embodiments according to FIG. 1 and FIG. 2 are combined in a pipe arrangement 1, wherein the valve position of the further first functional element formed as a valve is influenced depending on the status parameters detected by the first functional element 4 formed as a measurement transducer. The second functional element 5 acquires the data from the sensor via electromagnetic interaction and influences the valve via magnetic interaction. For this purpose, the second functional element 5 is formed as a control device.

1. A pipe arrangement for transporting a temperature control medium, comprising a base body made of polymeric material, wherein the base body has at least one fluid channel which receives the temperature control medium, and wherein at least one first functional element which is associated with the fluid channel is accommodated in the base body, wherein the first functional element interacts with a second functional element by means of electromagnetic and/or magnetic interaction.

2. The pipe arrangement according to claim 1, wherein the second functional element is arranged outside the base body.

3. The pipe arrangement according to claim 1, wherein the first functional element influences the volume flow of the temperature control medium.

4. The pipe arrangement according to claim 1, wherein the first functional element contains controllable, movable elements.

5. The pipe arrangement according to claim 1, wherein the second functional element is formed as a control device.

6. The pipe arrangement according to claim 1, wherein the first functional element detects status parameters of the temperature control medium.

7. The pipe arrangement according to claim 6, wherein the second functional element is formed as a measurement transducer.

8. The pipe arrangement according to claim 1, wherein data transmission between the first functional element and the second functional element takes place via electromagnetic interaction.

9. The pipe arrangement according to claim 1, wherein the base body has an inner wall that bounds the fluid channel and an outer wall, wherein the first functional element is allocated to the inner wall and the second functional element is allocated to the outer wall.

10. The pipe arrangement according to claim 1, wherein the base body is formed as a quick connector.

11. The pipe arrangement according to claim 1, wherein the base body is formed as a plastic tube.

12. The pipe arrangement according to claim 1, wherein the base body is formed as a blow-molded part.
